(19) United States
(12) Patent Application Publication
(10) Pub. No.: US 2016/0012264 A1
(43) Pub. Date: Jan. 14, 2016

(54) METHOD AND SYSTEM FOR AUTOMATICALLY COLLECTING INSPECTION RECORDS

(71) Applicant: proeasy network solutions co., LTD., Hsinchu County (TW)

(72) Inventor: Hsing-Hung Lu, Hsinchu County (TW)

(21) Appl. No.: 14/664,904

(22) Filed: Mar. 22, 2015

(30) Foreign Application Priority Data
Jul. 11, 2014 (TW) 103123958

(51) Int. Cl. G06K 7/10; H04W 4/02

(52) U.S. Cl. CPC G06K 7/10386; G06K 7/10198; H04W 4/02

(57) ABSTRACT

A method and a system for automatically collecting inspection records are provided. The method includes connecting to a chip installed on at least one location by wire through a mobile device to provide a power to the chip. The method also includes changing a variable value recorded in a memory unit of the chip when the chip receives the power, encapsulating the variable value, a serial number of the chip, and inspection relevant information corresponding to the at least one location into a token, and transmitting the token to the mobile device. The method further includes transmitting a signal including the serial number, the variable value, and the inspection relevant information to a management terminal according to the token when the mobile device receives the token and recording an inspection record corresponding to the at least one location according to the signal by the management terminal.

### CROSS-REFERENCE TO RELATED APPLICATION

This application claims the priority benefit of Taiwan application serial no. 103123958, filed on Jul. 11, 2014. The entirety of the above-mentioned patent application is hereby incorporated by reference herein and made a part of this specification.

### BACKGROUND OF THE INVENTION

1. Field of the Invention

The invention relates to a method and a system for automatically collecting inspection records, and more particularly relates to a method and a system for automatically collecting inspection records corresponding to plants, machines, and equipment at multiple locations.

2. Description of Related Art

Due to the progress in technology and development of various industries in the recent years, automated production and management of plants, machines, and equipment in factories has become a trend for many industries. For example, industry costs, production capacity, human resources, etc. are all considered as indexes of competition between companies. Therefore, how to reduce industry costs, increase production capacity, and utilize human resources more efficiently has become an important issue that needs to be addressed when it comes to production, manufacture, and management.

The traditional inspection and management method for places like large power plants and large factories is to put inspection records at different inspection points, and then the manager hires inspectors to patrol around at prescribed times to observe the situation or check on the instrument or equipment at the inspection points, make records, and return the inspection records to the manager. Apparently, the traditional method cannot instantly notify the manager of the actual situation of inspection of the machine, equipment, or plant if the inspector is unable to arrive at the inspection point of the machine, equipment, or plant at the prescribed time.

Now many large power plants, large factories, or large shopping malls that require site inspection are using wireless network, such as RFID (electronic tag, radio frequency identification) technology, by which a mobile device sends a signal for the management terminal to obtain information that the inspector is at the inspection point. However, the tag transmitted by such technology is fixed and cannot be changed dynamically. That is, the management terminal cannot confirm whether the inspector has actually patrolled to the inspection point by recognizing the discrepancy between the inspections of the inspector or determine whether the inspection record is abnormal from the fixed tag. Thus, how to effectively monitor and manage automatic patrol and inspection works for factories is one of the issues that those skilled in this field are working on.

### SUMMARY OF THE INVENTION

The invention provides a method and a system for automatically collecting inspection records, which are capable of automatically collecting the inspection records of multiple locations in a factory to ensure that the equipment, machine, or plant corresponding to each location is inspected.

The invention provides a method for automatically collecting an inspection record. The method includes connecting a mobile device to a chip installed on at least one location by wire to provide a power to the chip. The method also includes changing a variable value recorded in a memory unit of the chip when the chip receives the power, encapsulating the variable value in the memory unit and a serial number of the chip into a token, and transmitting the token to the mobile device. The method further includes transmitting a signal including the serial number of the chip and the variable value to a management terminal according to the token when the mobile device receives the token and recording the inspection record corresponding to the at least one location according to the signal by the management terminal.

In an embodiment of the invention, the step of connecting the mobile device to the chip installed on the at least one location by wire to provide the power to the chip includes: connecting the mobile device to the chip through a transmission line.

In an embodiment of the invention, the step of encapsulating the variable value in the memory unit and the serial number of the chip into the token and transmitting the token to the mobile device includes: transmitting the token to the mobile device through the transmission line by the chip.

In an embodiment of the invention, the step of encapsulating the variable value in the memory unit and the serial number of the chip into the token and transmitting the token to the mobile device includes: encapsulating the variable value, the serial number, and at least one piece of inspection relevant information corresponding to the at least one location into the token.

In an embodiment of the invention, after the step of transmitting the signal to the management terminal according to the token when the mobile device receives the token, the method includes: recognizing the at least one location according to the serial number and recording the number of times of inspection and an inspection time of the at least one location according to the changed variable value when the management terminal receives the signal, wherein the serial numbers of the chips installed on the locations differ from one another.

In an embodiment of the invention, the mobile device transmits the signal to the management terminal through a network.

In an embodiment of the invention, the network is a wireless fidelity (WiFi) network or a global system for mobile (GSM) network.

In an embodiment of the invention, the memory unit is a register or a non-volatile memory.

The invention provides a system for automatically collecting an inspection record. The system includes: a plurality of chips, at least one mobile device, and a management terminal. The chips are respectively installed on a plurality of locations. The at least one mobile device is configured to connect to the chip installed on at least one of the locations by wire to provide a power to the chip on the at least one location. The chip is configured to change a variable value recorded in a memory unit of the chip when the chip on the at least one location receives the power. The chip is further configured to encapsulate the variable value in the memory unit and a serial number of the chip into a token and transmit the token to the at least one mobile device. The at least one mobile device is configured to transmit a signal to the management terminal according to the token when the at least one mobile device receives the token, wherein the signal includes the serial number of the chip and the variable value. The management terminal is configured to record the inspection record corresponding to the at least one location according to the signal.

In an embodiment of the invention, the at least one mobile device is further configured to connect to the chip through a transmission line.

In an embodiment of the invention, the chip is further configured to transmit the token to the at least one mobile device through the transmission line.

In an embodiment of the invention, the chip is further configured to encapsulate the variable value, the serial number, and at least one piece of inspection relevant information corresponding to the at least one location into the token.

In an embodiment of the invention, the management terminal is further configured to recognize the at least one location according to the serial number and record the number of times of inspection and an inspection time of the at least one location according to the changed variable value when the management terminal receives the signal, wherein the serial numbers of the chips installed on the locations differ from one another.

In an embodiment of the invention, the mobile device is further configured to transmit the signal to the management terminal through a network.

In an embodiment of the invention, the network is a wireless fidelity (WiFi) network or a global system for mobile (GSM) network.

In an embodiment of the invention, the memory unit is a register or a non-volatile memory.

Based on the above, the method and system for automatically collecting the inspection records according to the invention effectively monitor whether the inspector patrols around to inspect the equipment, machine, or plant at each location and obtain the inspection information corresponding to the equipment, machine, or plant at each location.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram showing a system for automatically collecting inspection records according to an exemplary embodiment.

FIG. 2A is a schematic diagram of a token according to an exemplary embodiment.

FIG. 2B is a schematic diagram of the token according to another exemplary embodiment.

FIG. 3A to FIG. 3D are examples of changing a variable value in a chip according to an exemplary embodiment.

FIG. 4 shows an example of operating the chip, a mobile device, and a management terminal according to an exemplary embodiment.

FIG. 5 shows an example of the management terminal recording the inspection record corresponding to a machine according to a signal in an exemplary embodiment.

FIG. 6 is a flowchart showing a method for automatically collecting inspection records according to an exemplary embodiment.

### DESCRIPTION OF THE EMBODIMENTS

In order to effectively monitor whether an inspector patrols to every location in a factory to inspect the equipment, machine, or plant corresponding to each location, the invention connects a mobile device to a chip installed at the location of the equipment, machine, or plant by wire for the mobile device to provide power to the chip. By this power supply mechanism, an inspection record corresponding to the equipment, machine, or plant at each location is obtained instantly. Accordingly, the invention effectively manages and controls the inspection of the equipment, machine, or plant at each location. Specifically, the location described above may refer to a machine room in a factory of an industry or any one or a plurality of locations in the factory. In particular, these locations may also correspond to machines or equipment used for management, manufacture, or production in the factories of various industries. In this exemplary embodiment, a plurality of machines in a factory are described as an example to explain an operation of a system for automatically collecting inspection records.

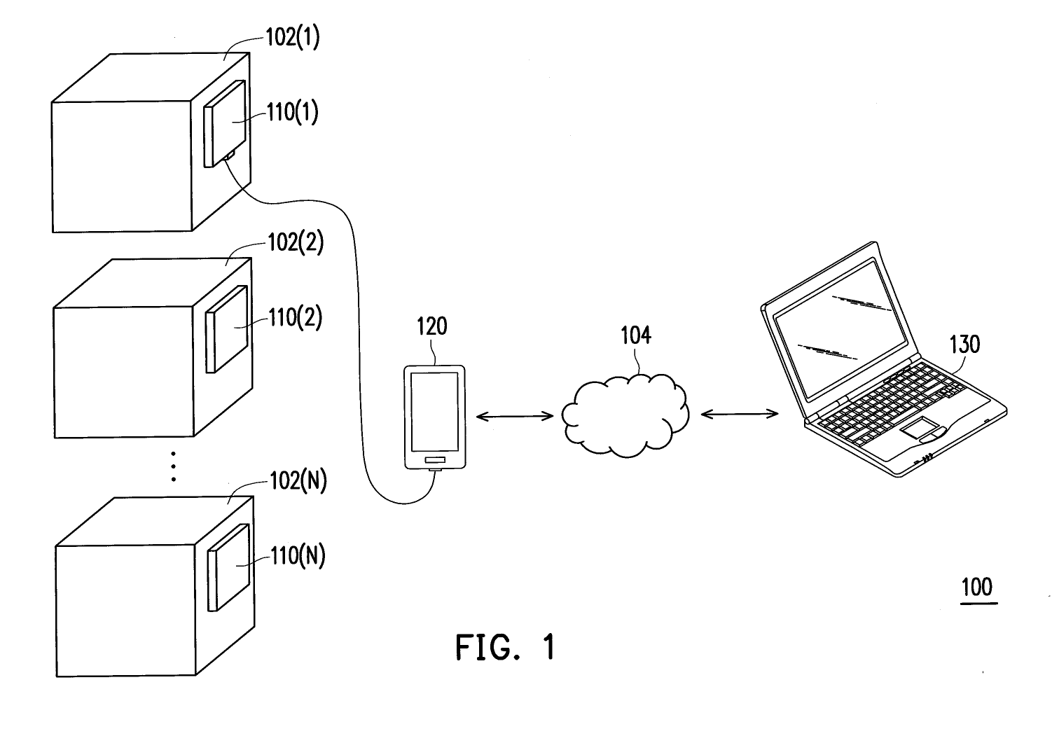

FIG. 1 is a schematic diagram showing a system for automatically collecting inspection records according to an exemplary embodiment.

With reference to FIG. 1, a system 100 for automatically collecting an inspection record includes a plurality of chips 110(1)-110(N), a plurality of machines 102(1)-102(N), a mobile device 120, and a management terminal 130.

The chips 110(1)-110(N) are respectively installed on the machines 102(1)-102(N). The chips 110(1)-110(N) may respectively include a microprocessor (e.g. central processing unit (CPU)), a controller, and an application specific integrated circuit (ASIC) or the like, for example. Particularly, in this exemplary embodiment, each of the chips 110(1)-110(N) includes a memory unit (not shown). The memory unit in each of the chips 110(1)-110(N) installed on the respective machines 102(1)-102(N) stores a serial number and a variable value corresponding to each of the chips 110(1)-110(N), and the serial numbers of the chips of the machines differ from one another. In other words, the serial numbers recorded in the memory units of the chips 110(1)-110(N) respectively represent the machines 102(1)-102(N). Moreover, in this exemplary embodiment, the memory unit is a register or a non-volatile memory. The non-volatile memory may be a read-only memory (ROM) and a flash memory, for example.

In this exemplary embodiment, the machines 102(1)-102(N) may correspond to management, manufacturing, or production machines that are used in factories of various industries. The aforesaid machines may be machines or equipment for food-related industry, textile industry, chemical material industry, electronic component manufacturing industry, electrical equipment manufacturing industry, and so on, for example. However, it should be noted that the invention is not limited to the foregoing. For example, in another exemplary embodiment, the machines 102(1)-102(N) may be any one or a plurality of locations in a machine room or plant of the factories of the aforementioned industries.

The mobile device 120 is configured to be connected to the chips 110(1)-110(N) installed in the machines 102(1)-102(N) by wire to provide a power to the chips 110(1)-110(N) of the machines 102(1)-102(N), and configured to transmit a signal corresponding to the inspection records of the machines 102(1)-102(N) to the management terminal 130 through a network 104. It should be understood that one mobile device 120 and one management terminal 130 are described in this exemplary embodiment as an example, but the invention is not limited thereto. For example, the system 100 may include a plurality of mobile devices and a plurality of management terminals, and each of the mobile devices performs data transmission with each management terminal through the network 104. In this exemplary embodiment, the network 104 is a wireless fidelity (WiFi) network or a global system for mobile (GSM) network. However, it should be noted that, in another exemplary embodiment, the network 104 may be other suitable network communication protocols. The disclosure is not intended to limit the type of the network 104.

The management terminal 130 is configured to record the inspection records respectively corresponding to the machines 102(1)-102(N) according to the signal received from the mobile device 120. In this exemplary embodiment, the management terminal 130 may be a server, a portable electronic device (e.g. personal digital assistant (PDA), laptop computer, and tablet computer), or even a non-portable electronic device (e.g. general desktop computer) or other electronic devices that can be connected to the network 104.

An example is given below in order to more clearly explain the operation of the chip, the mobile device, and the management terminal in the system 100.

Specifically, the mobile device 120 is connected to the chip 110(1) on the machine 102(1) by wire, so as to provide the power to the chip 110(1). For example, the mobile device 120 is connected to the chip 110(1) installed on the machine 102(1) by a transmission line 106. When the chip 110(1) on the machine 102(1) receives the power, the chip 110(1) changes the variable value recorded in the memory unit of the chip 110(1). Then, the chip 110(1) encapsulates the variable value in the memory unit and the serial number of the chip into a token and transmits the token to the mobile device 120 through the transmission line 106.

When the mobile device 120 receives the token, a signal is transmitted to the management terminal 130 according to the token. Because the signal includes the serial number of the chip 110(1) and the variable value, the management terminal 130 records the inspection record corresponding to the machine 102(1) according to the signal.

It should be noted that, in the operation of connecting the mobile device 120 to the chip 110(1) on the machine 102(1) to provide the power to the chip 110(1) and transmitting the token from the chip 110(1) to the mobile device 120, the power or the information is transmitted through the transmission line 106. Specifically, in this exemplary embodiment, the transmission line 106 may be a transmission line that conforms to bus standards, such as universal serial bus (USB), serial advanced technology attachment (SATA), IEEE 1394, and Thunderbolt. However, in another exemplary embodiment, the transmission line 106 may conform to other bus standards. The disclosure is not intended to limit the type of the transmission line 106.

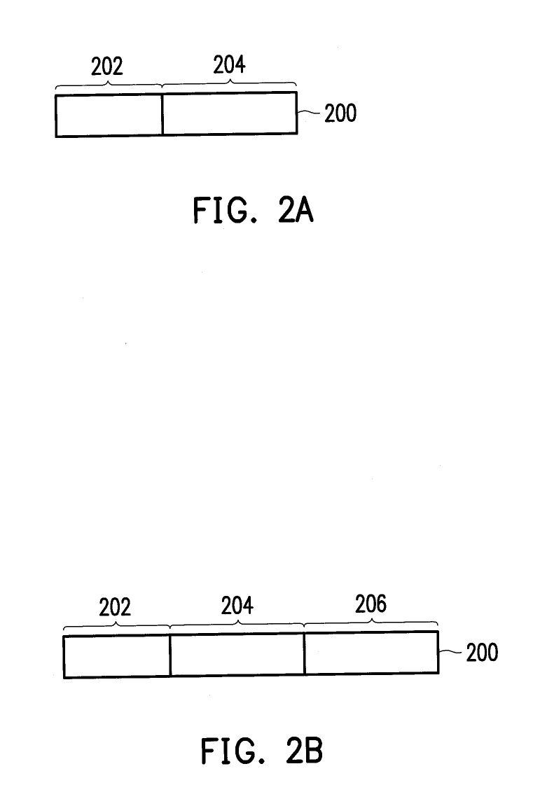

FIG. 2A is a schematic diagram of the token according to an exemplary embodiment, and FIG. 2B is a schematic diagram of the token according to another exemplary embodiment.

With reference to FIG. 2A, a token 200 includes a first portion 202 and a second portion 204, wherein the first portion 202 is configured for recording the serial number of the chip, and the second portion 204 is configured for recording the variable value recorded in the memory unit of the chip. For example, in this exemplary embodiment, after the chip 110(1) receives the power and changes the variable value recorded in the memory unit thereof, the chip 110(1) encapsulates the changed variable value and the serial number of the chip 110(1) into the token 200. For instance, the chip 110(1) puts the serial number in the first portion 202 of the token 200 and puts the variable value in the second portion 204 of the token 200. In particular, the chip 110(1) may encode and encrypt the serial number and the variable value and then encapsulate them into the token 200 and transmit the token 200 to the mobile device 120. It should be noted that an encapsulation form of the token 200 of the invention is not limited to the above. In another exemplary embodiment, the token 200 may be divided into more fields according to the information that is to be transmitted. With reference to FIG. 2B, the token 200 further includes a third portion 206 for recording inspection relevant information corresponding to the machine 102(1) of the chip 110(1). For example, the inspection relevant information includes inspection contents and items related to the space of each machine, equipment, or machine room, such as real-time information and environmental parameters of the current, voltage, temperature, humidity, and hardware status. However, it should be noted that the invention is not limited thereto.

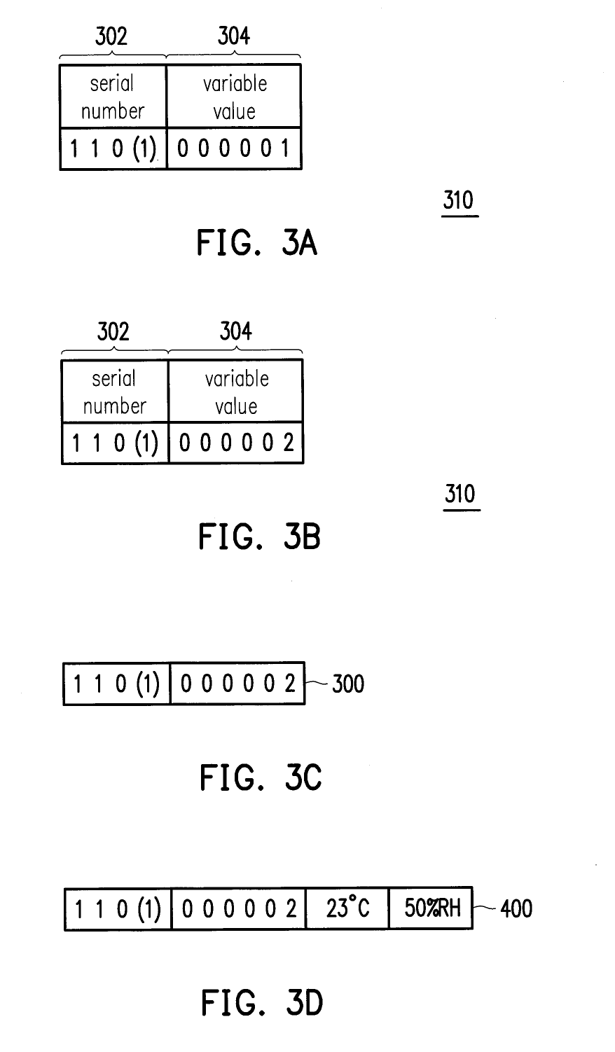

FIG. 3A to FIG. 3D are examples of changing the variable value in the chip according to an exemplary embodiment.

With reference to FIG. 3A, here it is provided that the serial number and the variable value corresponding to the chip 110(1), as stored in the memory unit of the chip 110(1), are “110(1)” and “000001”. Thus, as shown in a temporary table 310, the memory unit of the chip 110(1) records a serial number 302 as “110(1)” and records a variable value 304 as “000001”.

With reference to FIG. 3B and FIG. 3C, in this exemplary embodiment, whenever the chip on the machine receives the power, the chip changes the variable value recorded in the memory unit of the chip. For example, in the case of the serial number and the variable value recorded in the memory unit as shown in FIG. 3A, when the chip 110(1) receives the power from the mobile device 120, the variable value 304 recorded in the memory unit of the chip 110(1) is changed to “000002” (as indicated by the variable value 304 of FIG. 3B). Then, as shown in FIG. 3C, the chip 110(1) encodes the variable value 304 (i.e. “000002”) in the memory unit and the serial number 302 (i.e. “110(1)”) of the chip and encapsulates them into a token 300. Also, in another exemplary embodiment, when the mobile device 120 is connected to the chip 110(1) corresponding to the machine 102(1) by wire, the chip 110(1) provides a user interface to the mobile device 120 to be displayed on the mobile device 120, which allows the inspector to input the inspection relevant information corresponding to the machine 102(1). Moreover, the inspector may use the mobile device 120 to capture an image of the inspected location and upload the image through the user interface displayed on the mobile device 120 as the inspection relevant information. Accordingly, as shown in FIG. 3D, the chip 110(1) encapsulates the serial number “110(1)”, the variable value “000002”, and the inspection relevant information corresponding to the machine 102(1) (e.g. the temperature “23° C.” and humidity “50% RH” of the machine 102(1)) together into a token 400.

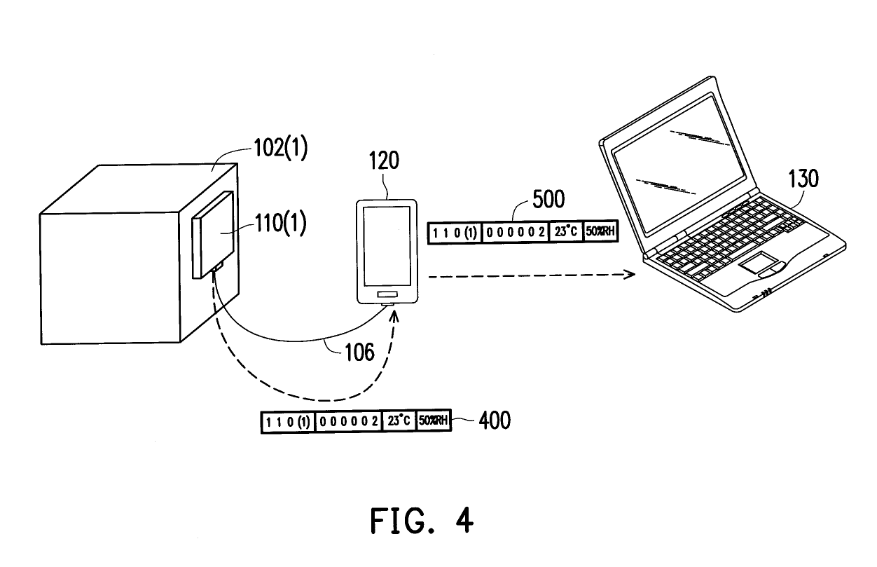

FIG. 4 shows an example of operating the chip, the mobile device, and the management terminal according to an exemplary embodiment.

With reference to FIG. 4, the chip 110(1) transmits the encapsulated token 400 to the mobile device 120 through the transmission line 106. Then, when the mobile device 120 receives the token 400, a signal 500 is transmitted to the management terminal 130 according to the token 400. Particularly, the signal 500 includes the serial number “110(1)” of the chip 110(1), the variable value “000002”, and the temperature “23° C.” and the humidity “50% RH” of the machine 102(1), as recorded in the token 400. Thus, the management terminal 130 records the inspection record corresponding to the machine 102(1) according to the signal 500. For example, when the management terminal 130 receives the signal 500, the signal 500 is decoded for obtaining the serial number corresponding to the chip 110(1), the variable value, and the inspection relevant information corresponding to the machine 102(1). Since the serial number of the chip 110(1) represents the machine 102(1), the management terminal 130 recognizes the machine 102(1) according to the serial number (i.e. “110(1)”) and records the inspection record related to the machine 102(1) according to the changed variable value (i.e. “000002”).

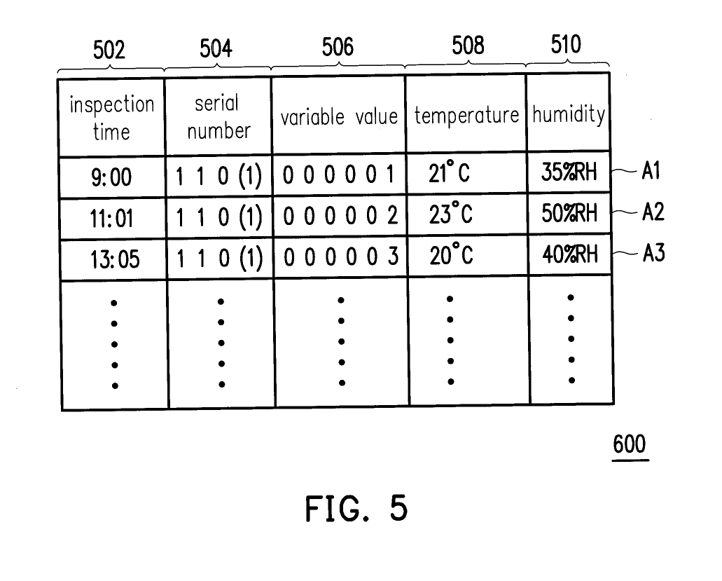

FIG. 5 shows an example of the management terminal recording the inspection record corresponding to the machine according to the signal in an exemplary embodiment.

With reference to FIG. 5, in the operation that the management terminal recognizes the machine according to the serial number of the chip and records the number of times of inspection and the inspection time of the machine according to the changed variable value, the management terminal 130 records a time point of receiving the signal as the inspection time in an inspection time field 502 of an inspection information table 600 in a database thereof. For example, a signal received at 9:00 AM includes the serial number, the variable value, and the temperature and humidity serving as the inspection relevant information, which are “110(1)”, “000001”, “21° C.”, and “35% RH” respectively. Therefore, the management terminal 130 records the foregoing information in a serial number field 504, a variable value field 506, a temperature field 508, and a humidity field 510 respectively (as shown by an inspection record A1). Accordingly, a signal received at 13:01 PM indicates that the serial number, the variable value, the temperature, and the humidity of the machine are “110(1)”, “000002”, “23° C.”, and “50% RH” respectively. A signal received at 13:05 PM indicates that the serial number, the variable value, the temperature, and the humidity of the machine are “110(1)”, “000003”, “20° C.”, and “40% RH” respectively. Thus, the management terminal 130 records the foregoing information as an inspection record A2 and an inspection record A3. It should be noted that the management terminal 130 obtains the inspection time and the number of times of inspection of the machine 102(1) corresponding to the chip 110(1) according to the inspection record A1, the inspection record A2, and the inspection record A3, and thereby determines whether the machine 102(1) is inspected in a prescribed time range. In particular, the management terminal 130 may further determine whether the number of times of inspection and the inspection time of the machine 102(1) are abnormal according to the change of the variable value in the variable value field 606 of the inspection record A1, the inspection record A2, and the inspection record A3. In addition, the inspection information table 600 is merely an example and should not be construed to limit the invention.

Specifically, in this exemplary embodiment, when the inspector patrols to inspect the equipment, machines, or plants in the factory, the inspector connects the mobile device to the chip on one or multiple locations of the equipment, machine, or plant that is currently inspected through the transmission line, so as to provide the power to the chip. Accordingly, when the chip on one or multiple locations of the equipment, machine, or plant that is currently inspected receives the power, the chip starts executing the aforementioned operation to change the variable value, encapsulate, and transmit the token. That is, the chip changes the value by the power supply mechanism. Thereby, when the management terminal receives the signal, whether the inspector patrols around to inspect each plant, machine, or equipment can be confirmed according to the change of the currently received variable value corresponding to each plant, machine, or equipment and the previously received variable value corresponding to each plant, machine, or equipment. In addition, through the connection between the mobile device and the chip on one or multiple locations of equipment, machine, or plant, the invention provides the function that allows the inspector to input the inspection relevant information into the mobile device and transmit the inspection relevant information to the management terminal. Particularly, according to the invention, the serial number of the chip corresponding to each plant, machine, or equipment, the changed variable value, and the inspection relevant information received from the chip are instantly transmitted to the management terminal through the mobile device. According to the time point of receiving the signal, the management terminal determines whether the inspector patrols to the plant, machine, or equipment in the prescribed time range to perform inspection of the relevant inspection items corresponding to the plant, machine, or equipment. It is worth mentioning that, according to the invention, the chip is installed at a fixed location in the machine, equipment, or plant that is to be inspected. In other words, the chip of the invention is applicable to the inspection procedure of a large number of machines, equipment, and plants in large factories of various industries. With the automatic collection and management of the management terminal, the efficiency of inspection record collection is improved, and with the wired transmission and power supply mechanism of the transmission line, the costs of the automatic inspection record collecting system are reduced effectively.

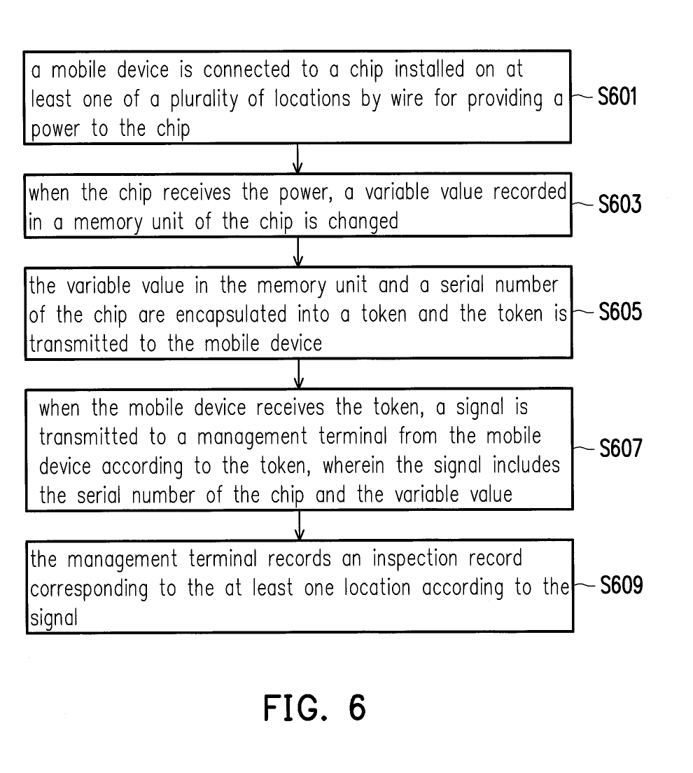

FIG. 6 is a flowchart showing a method for automatically collecting inspection records according to an exemplary embodiment.

With reference to FIG. 6, first, in Step S601, a mobile device is connected to a chip installed on at least one of a plurality of locations by wire for providing a power to the chip. In Step S603, when the chip receives the power, a variable value recorded in a memory unit of the chip is changed. Then, in Step S605, the variable value in the memory unit and a serial number of the chip are encapsulated into a token and the token is transmitted to the mobile device. In Step S607, when the mobile device receives the token, a signal is transmitted to a management terminal through the mobile device according to the token, wherein the signal includes the serial number of the chip and the variable value. Thereafter, in Step S609, the management terminal records an inspection record corresponding to the at least one location according to the signal.

Details of each step of FIG. 6 have been specified in the previous descriptions and thus are not repeated hereinafter. It should be noted that each step of FIG. 6 may be implemented as a plurality of program codes or circuits, and the invention is not limited to the above. In addition, the method of FIG. 6 may be used in combination with the above-described embodiments or be used solely. Nevertheless, the invention is not limited thereto.

To sum up, in the operation of automatically collecting the inspection records corresponding to the plants, machines, and equipment at multiple locations in the factory, the method and the system of the invention connect the chips installed at multiple locations with the mobile device by wire and utilize the mechanism of supplying power from the mobile device to the chip, such that the management terminal can instantly obtain the inspection record, such as the inspection time and the number of times of inspection, corresponding to the equipment at each location, thereby effectively monitoring whether the inspector patrols to inspect each location in the prescribed time range.

What is claimed is:

1. An automatic inspection record collecting method, comprising:
connecting a mobile device to a chip installed on at least one of a plurality of locations by wire to provide a power to the chip;
changing a variable value recorded in a memory unit of the chip when the chip receives the power;
encapsulating the variable value in the memory unit and a serial number of the chip into a token and transmitting the token from the chip to the mobile device;
transmitting a signal from the mobile device to a management terminal according to the token when the mobile device receives the token, wherein the signal comprises the serial number of the chip and the variable value; and
recording an inspection record corresponding to the at least one location according to the signal by the management terminal.

2. The automatic inspection record collecting method according to claim 1, wherein the step of connecting the mobile device to the chip installed on the at least one location by wire to provide the power to the chip comprises:
connecting the mobile device to the chip through a transmission line.

3. The automatic inspection record collecting method according to claim 2, wherein the step of encapsulating the variable value in the memory unit and the serial number of the chip into the token and transmitting the token from the chip to the mobile device comprises:
transmitting the token to the mobile device through the transmission line by the chip.

4. The automatic inspection record collecting method according to claim 3, wherein the step of encapsulating the variable value in the memory unit and the serial number of the chip into the token and transmitting the token from the chip to the mobile device comprises:
encapsulating the variable value, the serial number, and at least one piece of inspection relevant information corresponding to the at least one location into the token.

5. The automatic inspection record collecting method according to claim 4, further comprising after transmitting the signal to the management terminal according to the token,
recognizing the at least one location according to the serial number and recording the number of times of inspection and an inspection time of the at least one location according to the changed variable value when the management terminal receives the signal,
wherein the serial numbers of the chips installed on the locations differ from one another.

6. The automatic inspection record collecting method according to claim 5, wherein the mobile device transmits the signal to the management terminal through a network.

7. The automatic inspection record collecting method according to claim 6, wherein the network is a wireless fidelity (WiFi) network or a global system for mobile (GSM) network.

8. The automatic inspection record collecting method according to claim 1, wherein the memory unit is a register or a non-volatile memory.

9. An automatic inspection record collecting system, comprising:
a plurality of chips respectively installed on a plurality of locations;
at least one mobile device configured to connect to the chip installed on at least one of the locations by wire to provide a power to the chip on the at least one location; and
a management terminal,
wherein the chip changes a variable value recorded in a memory unit of the chip when the chip on the at least one location receives the power,
wherein the chip encapsulates the variable value in the memory unit and a serial number of the chip into a token and transmit the token to the at least one mobile device,
wherein the at least one mobile device transmits a signal to the management terminal according to the token when the at least one mobile device receives the token, wherein the signal comprises the serial number of the chip and the variable value, and
wherein the management terminal records an inspection record corresponding to the at least one location according to the signal.

10. The automatic inspection record collecting system according to claim 9, wherein the at least one mobile device connects to the chip through a transmission line.

11. The automatic inspection record collecting system according to claim 10, wherein the chip transmits the token to the at least one mobile device through the transmission line.

12. The automatic inspection record collecting system according to claim 11, wherein the chip encapsulates the variable value, the serial number, and at least one piece of inspection relevant information corresponding to the at least one location into the token.

13. The automatic inspection record collecting system according to claim 12, wherein the management terminal recognizes the at least one location according to the serial number and record the number of times of inspection and an inspection time of the at least one location according to the changed variable value when the management terminal receives the signal,
wherein the serial numbers of the chips installed on the locations differ from one another.

14. The automatic inspection record collecting system according to claim 13, wherein the mobile device transmits the signal to the management terminal through a network.

15. The automatic inspection record collecting system according to claim 14, wherein the network is a wireless fidelity (WiFi) network or a global system for mobile (GSM) network.

16. The automatic inspection record collecting system according to claim 9, wherein the memory unit is a register or a non-volatile memory.
